(19) United States
(12) Patent Application Publication
(10) Pub. No.: US 2008/0005461 A1
(43) Pub. Date: Jan. 3, 2008

(54) Power-saving control apparatus, power-saving control method, and computer product

(75) Inventors: Seiji Toda, Kawasaki (JP); Mitsuhiko Ohta, Kawasaki (JP); Arata Ejiri, Kawasaki (JP); Yasuo Noguchi, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/899,886

(22) Filed: Sep. 7, 2007

Related U.S. Application Data
(63) Continuation of application No. PCT/JP2005/004813, filed on Mar. 17, 2005.

(51) Int. Cl. G06F 12/00

(52) U.S. Cl. 711/112

(57) ABSTRACT

A disk managing apparatus is configured so that an operation mode of a disk device is set to be in a standby mode by default and an access managing unit continuously acquires an operation state of the disk device. Upon receiving a disk access request, and if the operation mode is the standby mode, the access managing unit checks the operation mode and sends a query about accessibility of the disk device to the power managing unit. Upon receiving an access permission, the access managing unit accesses the disk device and switches the operation mode to be in the active state. Furthermore, the data-transfer processing unit transfers frequently-accessed data to a frequently-accessed disk device.

This is a continuation filed under 35 U.S.C. § 111(a), of International Application No. PCT/JP2005/004813, filed Mar. 17, 2005.

### BACKGROUND OF THE INVENTION

1. Field of the Invention

The present invention relates to a technology for performing a power-saving control on a plurality of information storage devices.

2. Description of the Related Art

A storage system (a storage device) is known in the art that includes a plurality of magnetic disk devices (hereinafter, “disk devices”) to increase the memory capacity and to improve the performance. In such a storage device, it is necessary to secure maximum power consumption necessary for activating all the disk devices. In other words, if a power source that can assure the maximum power consumption is not available, the storage device cannot be installed.

One approach to reduce the power consumption is to decrease the number of the disk devices; however, this approach leads to lower storage capacity. In another approach, the power consumption of the entire storage device is controlled by controlling an operation mode of each of the disk devices.

For example, a conventional power management method is disclosed in Japanese Patent Application Laid-Open No. 2001-331243. In the conventional power management method, amount of data input/output to/from each of the disk devices is recorded as time passes. The record is then analyzed to see if any disk device exhibits a cyclic access pattern. If a disk device exhibits a cyclic access pattern, then it is determined if it is possible to estimate a period during which the amount of data input/output to/from any disk device becomes zero. If such a period can be estimated for a disk device, then that disk device is forced to enter a power-saving mode during that period.

In the conventional technology, however, if the amount of data input/output to/from a disk device is not cyclic, it is difficult to switch the operation mode of the disk devices to the power-saving mode; and therefore, a sufficient power-saving effect can not be obtained.

Furthermore, unless a large number of disk devices are switched to the power-saving mode, the power consumption of the entire storage device cannot be reduced effectively.

The above problems can not be neglected in view of the fact that there has been a trend to increase the number of the disk devices in the storage device to satisfy a requirement of a large storage capacity and/or a high-speed input/output processing.

### SUMMARY OF THE INVENTION

It is an object of the present invention to at least partially solve the problems in the conventional technology.

According to an aspect of the present invention, there is provided an apparatus including a storage unit that stores therein operation information indicative of operation state of each of a plurality of information storage devices; a power calculating unit that calculates power information including current power consumption of each of the information storage devices and total power consumption of all the information storage devices based on the operation information; and an access managing unit that, upon receiving an access request for a target information storage device checks if the target information storage device is in a standby state from the operation information in the storage unit, and if the target information storage device is in the standby state, switches the target information storage device to active state and permits access to the target information storage device when the power information satisfies certain condition.

According to another aspect of the present invention, there is provided a method including storing in a storage unit operation information indicative of operation state of each of a plurality of information storage devices; calculating power information including current power consumption of each of the information storage devices and total power consumption of all the information storage devices based on the operation information; and managing, upon receiving an access request for a target information storage device, including checking if the target information storage device is in a standby state from the operation information in the storage unit, and if the target information storage device is in the standby state, switching the target information storage device to active state and permitting access to the target information storage device when the power information satisfies certain condition.

According to still another aspect of the present invention, there is provided a computer-readable recording medium that stores therein a computer program that causes a computer to realize the above method.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram for explaining a concept of a disk management processing according to an embodiment of the present invention;

FIG. 2 is a schematic diagram for explaining a concept of a power-saving disk management processing according to the embodiment;

FIG. 3 is a schematic diagram for explaining a concept of a data transfer processing according to the embodiment;

FIG. 4 is a block diagram of a disk managing apparatus according to the embodiment;

FIG. 5A is a table for explaining operation modes of a disk device according to the embodiment;

FIG. 5B is a schematic diagram for explaining switching of the operation modes shown in FIG. 5A;

FIG. 6 is a table of an example of contents of disk information shown in FIG. 4;

FIG. 7 is a table of an example of contents of power management information shown in FIG. 4;

FIG. 8 is a table for explaining a data transfer processing performed by the data-transfer processing unit shown in FIG. 4;

FIG. 9 is a flowchart of a processing procedure of updating the disk information and the power management information shown in FIGS. 6 and 7;

FIG. 10 is a flowchart of a power-saving disk management processing according to the embodiment;

FIG. 11 is a flowchart of the data transfer processing according to the embodiment; and

FIG. 12 is a block diagram of a computer terminal that executes an access management program, a power management program, and a data-transfer processing program, according to the embodiment.

### DETAILED DESCRIPTION OF THE PREFERRED EMBODIMENTS

Exemplary embodiments of the present invention are explained in detail below with reference to the accompanying drawings. An example is explained below in which a power-saving control is performed on a disk device.

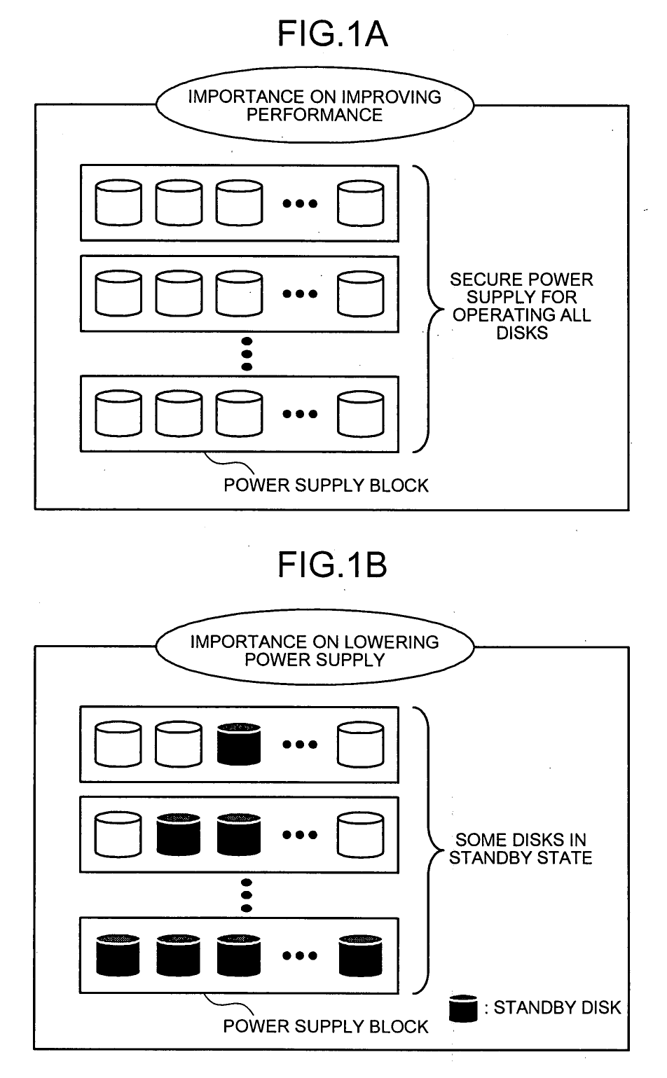

FIGS. 1A and 1B are schematic diagrams for explaining the differences between the concepts of the conventional disk management processing and a disk management processing according to an embodiment of the present invention. As shown in FIG. 1A, in the conventional disk management processing, importance is given to improvement of the performance. The improvement of the performance is achieved by employing techniques such as striping or mirroring in which pieces of input/output data are distributed to each of disk devices. In the conventional storage device, because importance is given to the improvement of the performance, it is necessary that all the disk devices are activated all the time. In other words, it is necessary to supply enough power to each of the disk devices all the time.

However, because number of the disk devices included in the storage device has been increased with an increase of a size of the storage device, it becomes difficult to assure an amount of power necessary for operating all the disk devices. Therefore, the number of the disk devices included in the storage device is suppressed when installing the storage device, so that a necessary amount of power is kept within an available range. In other words, although a capacity can be increased and a performance can be improved with an increase of the size of the storage device, there is a problem with a power supply caused by an increase of power consumption.

In response to the above issues, according to an embodiment of the present invention, importance is given to power-saving instead of performance. More specifically, as shown in FIG. 1B, in a storage device according to an embodiment, some of the disk devices are put in standby state. This configuration allows the power consumption of the entire storage device to be maintained below a tolerance value. In another embodiment, such a power control is performed for each of the power supply blocks, such as chassis or rack. Accordingly, it is possible to suppress the power consumption of each of the power supply blocks below a predetermined amount.

In another embodiment, if there is a disk device that has less access rate and a disk device that has high access rate, then data from the disk device with less access rate is moved to the disk device with high access rate, and the disk device with less access rate is put in standby state. Accordingly, it is possible to effectively suppress the power consumption.

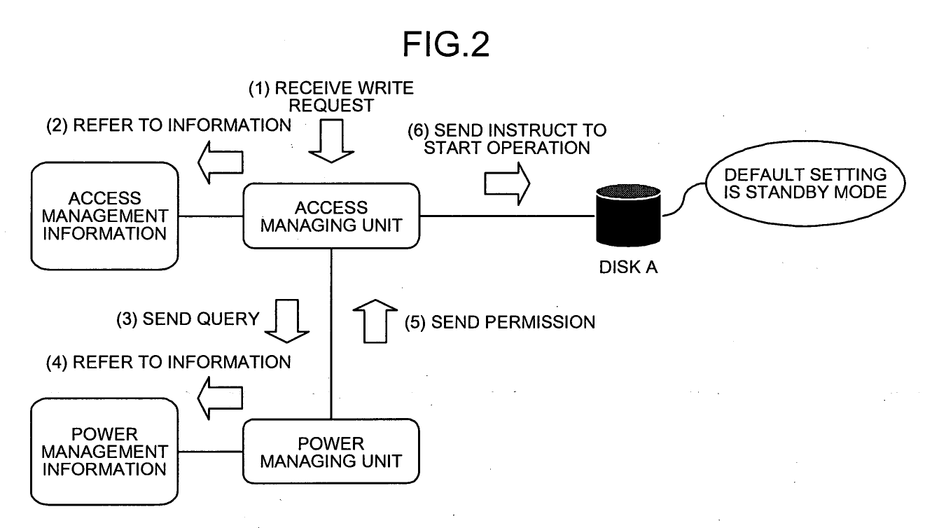

FIG. 2 is a schematic diagram for explaining the concept of power-saving disk management processing performed by the storage device according to the embodiment. The storage device includes an access managing unit that manages an access (input/output operation) to the disk devices and a power managing unit that manages an amount of power for each of the power supply blocks.

In the power-saving disk management processing, for example, upon receiving a write request to a certain disk device A from a server (see (1) of FIG. 2), the access managing unit refers to access management information that is information about input/output states of the disk devices. If the access management information indicates that the disk device A is in a standby mode, the access managing unit sends a query to the power managing unit about whether an operation of the disk device A can be started (see (3) of FIG. 2).

Upon receiving the query, the power managing unit refers to power management information that is information about tolerance and power consumption of the disk devices. If the power management information indicates that the disk device A can be operated in consideration of the power supply, the power managing unit sends a permission to the access managing unit (see (5) of FIG. 2). Upon receiving the permission, the access managing unit sends an instruction to the disk device to start operation (see (6) of FIG. 2), i.e., recover from the standby mode. When the disk device enters into an active mode, the access managing unit writes data to the disk device A based on the write request from the server.

According to the embodiment, a default setting of the operation mode of each of the disk devices, for example, the disk A shown in FIG. 2, is determined to be in the standby mode. In this manner, by determining the default setting of the disk device to be in the standby mode, a state of the disk device can be automatically switched to the standby mode when the input/output operation is not performed to each of the disk devices. Therefore, it is possible to improve a power saving effect and to reduce a processing load caused by switching the operation mode.

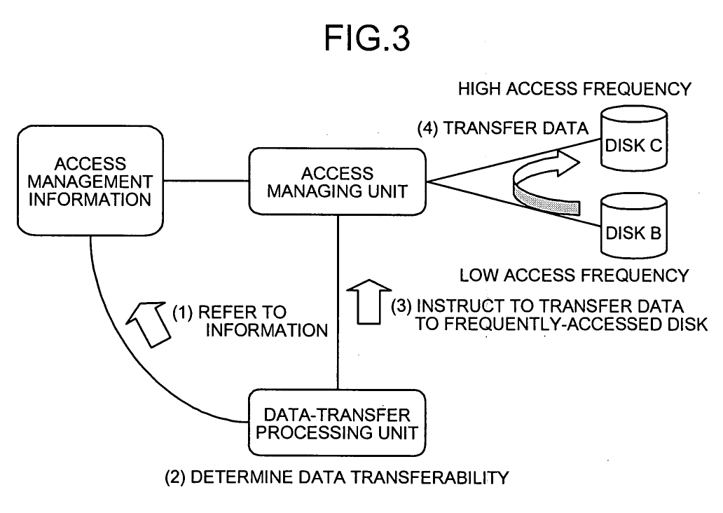

In the power-saving disk management processing, the number of the standby disks is positively increased by transferring data stored in a disk device that is less frequently accessed to another disk device that is frequently accessed. This is explained in detail with reference to FIG. 3.

As shown in FIG. 3, the storage device includes a data-transfer processing unit that performs the data transfer processing of transferring data among the disk devices. The data-transfer processing unit selects a predetermined pair of disk devices B and C, and refers to the access management information (see (1) of FIG. 3). The data-transfer processing unit determines whether it is possible to transfer data from one disk device B to the other disk device C based on two factors (see (2) of FIG. 3): overall access frequencies of the disk devices B and C, and access frequency of each data stored in the disk devices B and C. If it is possible to transfer data stored in the disk device B to the disk device C, i.e., if the disk device B has low access frequency and the disk device C has high access frequency, the data-transfer processing unit instructs the access managing unit to transfer data from the disk device B to the disk device C.

By performing the same data transfer processing on other disk devices, data distributed on the disk devices that are less frequently accessed are accumulated to the disk devices that are more frequently accessed. The less frequently accessed disk devices can be then automatically switched from the active mode to the standby mode thereby saving the power consumption.

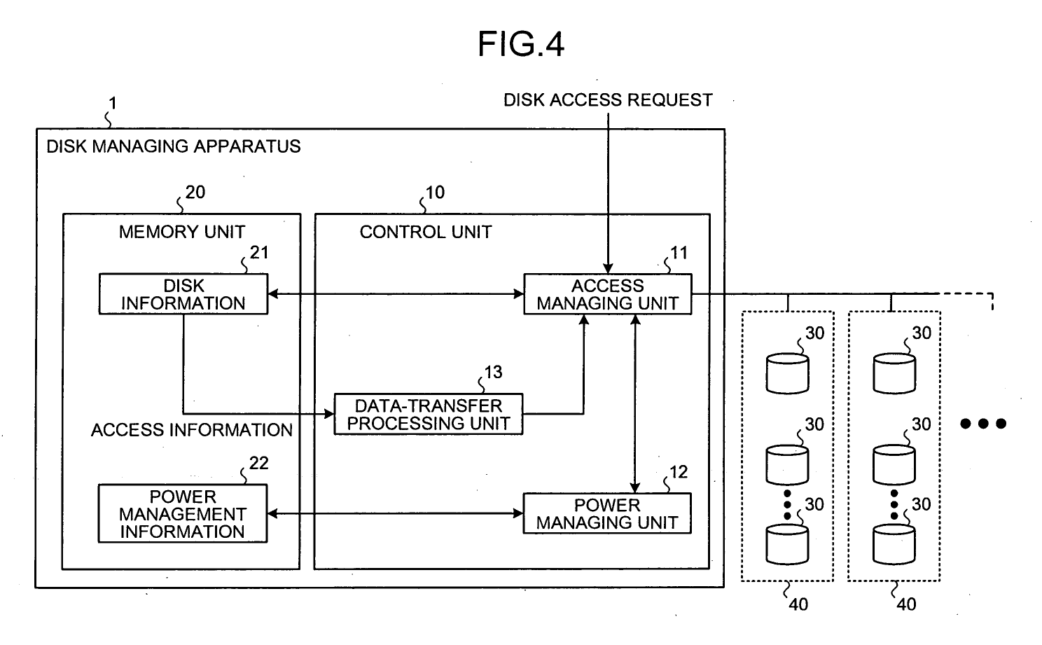

FIG. 4 is a block diagram of a disk managing apparatus 1 according to the embodiment. The disk managing apparatus 1 includes a control unit 10 and a memory unit 20. The disk managing apparatus 1 is connected to a plurality of power supply blocks 40 each including a plurality of disk devices 30.

The control unit 10 includes an access managing unit 11, a power managing unit 12, and a data-transfer processing unit 13. The memory unit 20 stores therein disk information 21 and power management information 22.

The control unit 10 receives a disk access request to a certain disk device D from among the disk devices 30 from a computer terminal such as a server (not shown), monitors an access status of the disk device D, and executes an input/output data to and from the disk device D.

The access managing unit 11 continuously monitors an operation state of the disk devices 30 and stores the disk information 21, which represents the result of the monitoring, to the memory unit 20. Upon receiving a disk access request for one or more of the disk devices 30, the access managing unit 11 sends a request of an access permission to the power managing unit 12 for those disk devices 30. Upon receiving a permission from the power managing unit 12, the access managing unit 11 executes input/output of data to and from those disk devices 30. Upon not receiving the permission, the access managing unit 11 does not execute the input/output. Although only one access managing unit 11 is shown in FIG. 4, as another embodiment, one access managing unit can be provided corresponding to each of the power supply blocks.

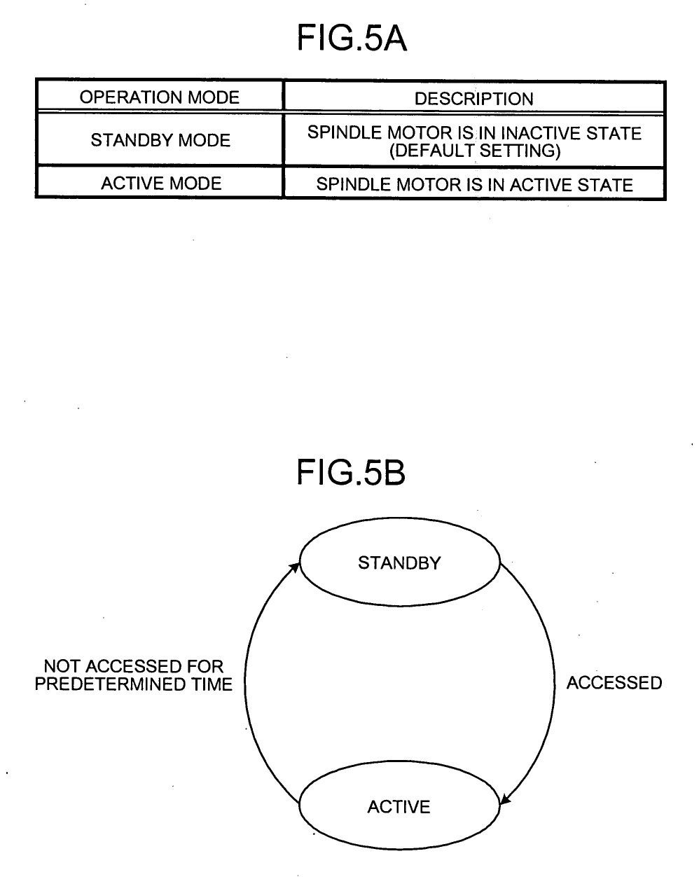

FIG. 5A is a table for explaining the operation mode of the disk devices 30. FIG. 5B is a schematic diagram for explaining a switching of the operation modes shown in FIG. 5A. A case has been explained here in which the disk devices 30 have two operation modes: standby mode and active mode.

The standby mode is such that the spindle motor of the disk device is in inactive state, while the active mode is such that the spindle motor is in active state. The power consumption of a typical disk device is the lowest when its spindle motor is in inactive state. In other words, from the viewpoint of power saving, it is preferable that more and more disk devices are in the standby mode.

As shown in FIG. 5A, the default operation mode of the disk devices 30 is the standby mode. In other words, as shown in FIG. 5B, if a disk device is not accessed for a predetermined time, its operation mode is automatically switched to the standby mode, while if the disk device is accessed, its operation mode is switched to the active mode. Although it is explained to automatically switch the operation mode of the disk devices, it is possible to have a configuration in which the access managing unit 11 controls the switching of the operation mode.

If the disk devices 30 perform a plurality of operation steps with different power consumption, it is possible to set one or more operation modes between the active mode and the standby mode and to control switching of the disk devices 30 among the operation modes.

Referring back to FIG. 4, upon receiving the write request to the disk device D from among the disk devices 30, the access managing unit 11 refers to the disk information 21 and checks the operation mode of the disk device D. When the disk device D is in the standby mode, the access managing unit 11 sends a query to the power managing unit 12 about whether data can be written to the disk device 30.

To write data, if the disk device D is in the standby mode, the disk device D needs to be switched from the standby mode to the active mode. However, if the amount of power required for the disk device D in the active mode added to the current total power exceeds the tolerance value, the disk device 30 can not be switched to the active mode. On the other hand, if the disk device D is already in the active mode, data can be written on the disk device D. Therefore, the access managing unit 11 sends a query to the power managing unit 12 about whether data can be written on the disk device D. Upon receiving a permission from the power managing unit 12, the access managing unit 11 performs a data input/output to and from the disk device D. Upon not receiving the permission, the access managing unit 11 does not perform the data input/output.

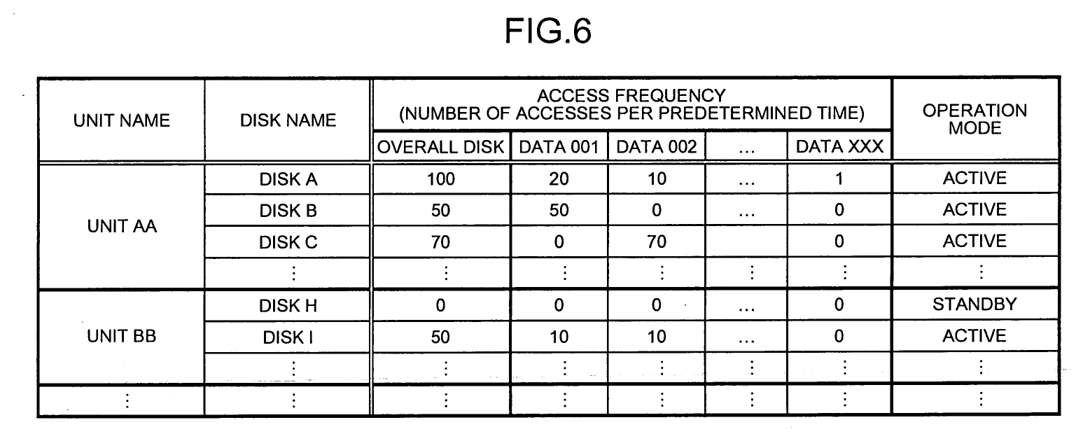

FIG. 6 is a table of an example of contents of the disk information 21. The disk information 21 includes unit name, disk name, access frequency, and operation mode, and is used for the management of the operation state of each of the disk devices 30. The unit name corresponds to a name of each of the power supply blocks 40 shown in FIG. 4.

The disk information 21 includes overall access frequency of each of the disk devices 30 (i.e., number of accesses per unit time), and access frequency of each data in each of the disk devices 30. In the example shown in FIG. 6, the overall access frequency of a disk A of a unit AA is 100, while the access frequency of data 001 in the disk A is 20. On the other hand, the overall access frequency of the disk H in a unit BB is zero, while the access frequency of data 001 in the disk H is also zero. Accordingly, the disk H has been put in the standby mode.

Referring back to FIG. 4, the power managing unit 12 manages the power consumption of each of the disk devices 30 and the power consumption of each of the power supply blocks 40, and performs a processing of an access permission/non-permission to a specific disk device 30 in response to a query from the access managing unit 11. The power managing unit 12 receives information on the operation mode of each of the disk devices 30 and updates the power management information 22 based on the received information. Upon receiving an access permission request from the access managing unit 11, the power managing unit 12 determines whether access is to be permitted based on the power management information 22.

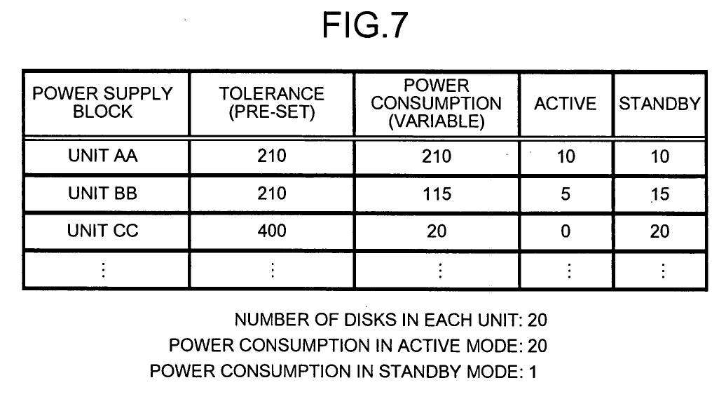

FIG. 7 is a table of an example of contents of the power management information 22. The power management information 22 contains name of power supply block, which is the same as the unit name shown in FIG. 6, tolerance, power consumption, number of disk devices in active mode, and number of disk devices in standby mode. The power management information 22 is used for managing amount of power of each of the disk devices included in each of the power supply blocks. The tolerance is a static value, i.e., a pre-set value, for each of the power supply blocks, while the power consumption is a variable value, i.e., it varies based on the current situation, that indicates current power consumption of the disk device.

In the example shown in FIG. 7, it is assumed that the number of the disk devices in each of the units is 20, the power consumption of each disk device when in the active mode is 20, and the power consumption of each disk device when in the standby mode is 1. As for a unit AA, 10 disk devices are in the active mode and 10 disk devices are in the standby mode. Therefore, current power consumption of the unit AA is 210 (=20×10+1×10).

Furthermore, because the tolerance of the unit AA is 210, the power consumption of the unit AA has reached its limit. At this example, upon receiving an access permission request to a disk device, which is in the standby mode, in the unit AA from the access managing unit 11, the power managing unit 12 will not permit an access to that disk device. On the other hand, upon receiving an access permission request to a disk device, which is in the standby mode, in a unit CC, because the power consumption of the unit CC is 20 while the tolerance is 400, the power consumption is not likely to exceed the tolerance even if the operation mode of that disk device is switched to the active mode. Therefore, the power managing unit 12 permits an access to that disk device.

Referring back to FIG. 4, the data-transfer processing unit 13 performs a data transfer processing of transferring data between two or more disk devices based on the disk information 21. More specifically, the data-transfer processing unit 13 acquires the access frequency (see FIG. 6) for each of the disk devices, and starts performing the data transfer processing in response to a trigger output from an interval timer or the like. Thereafter, the data transfer processing unit 13 selects a pair of the disk devices, and transfers relatively frequently-accessed data from one of disk devices to other of the relatively frequently-accessed disk devices.

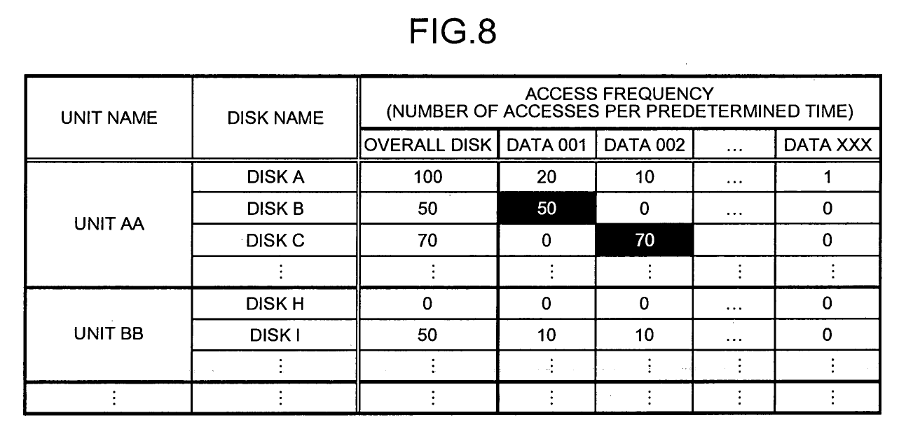

FIG. 8 is a table for explaining the data transfer processing performed by the data-transfer processing unit 13. The data-transfer processing unit 13 selects, for example, disks A and B in the unit AA. The overall access frequency of the disk A is 100, while the same of the disk B is 50. The disk B also includes data 001 of which access frequency is 50. Accordingly, the data-transfer processing unit 13 transfers the data 001, which is relatively frequently accessed among all data, from the disk B to the disk A, which is relatively frequently accessed among the disks A and B.

Assume now that the data-transfer processing unit 13 selects disks A and C in the unit AA as target disks for the data transfer processing. The overall access frequency of the disk A is 100, the same of the disk C is 70. The disk C also includes data 002 of which access frequency is 70. Therefore, the data-transfer processing unit 13 transfers the data 002, which is relatively frequently accessed among all data, from the disk C to the disk A.

Assume now that the data-transfer processing unit 13 selects the disk B in the unit AA and a disk I in the unit BB as target disks for the data transfer processing. Because the overall access frequency of both the disks B and I is 50, the data-transfer processing unit 13 does not perform the data transfer processing.

In this manner, the data-transfer processing unit 13 accumulates relatively frequently-accessed data in relatively frequently-accessed disk devices. When relatively frequently-accessed data from a disk device is moved, the overall access frequency of that disk device drops so that that disk device can be switched to the standby state. Therefore, it is possible to increase number of the disk devices that are in the standby mode. As a result, it is possible to effectively use the disk devices 30, and to save power in a storage device or a storage system configured with a plurality of the storage devices.

Referring back to FIG. 4, the memory unit 20 is configured with a memory device, such as a random access memory (RAM), and stores therein the disk information 21 and the power management information 22. Although the disk information 21 and the power management information 22 are shown separately, the disk information 21 and the power management information 22 can be combined.

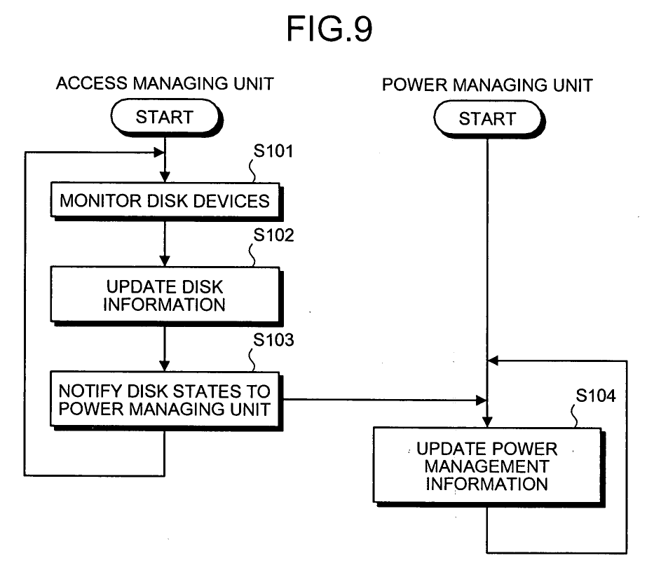

FIG. 9 is a flowchart of a processing procedure of updating the disk information 21 by the access managing unit 11 and updating the power management information 22 by the power managing unit 12. The access managing unit 11 continuously monitors the disk devices 30 (step S101) thereby acquiring operation information of each of the disk devices 30, and updates the disk information 21 based on the acquired operation information (step S102).

The access managing unit 11 extracts an operation state of each of the disk devices 30 from the operation information, and notifies the extracted operation states to the power managing unit 12 (step S103). The operation state is information related to power management (for example, “power consumption”, “active”, and “standby” shown in FIG. 7) The access managing unit 11 continuously repeats processes from step S101 to step S103. In this manner, the access managing unit 11 continuously updates the disk information 21 and notifies the operation state of each of the disk devices 30 to the power managing unit 12.

On the other hand, upon receiving the operation state of each of the disk devices 30 from the access managing unit 11, the power managing unit 12 updates the power management information 22 based on the received operation state (step S104). The power managing unit 12 repeats a process at step S104 every time the power managing unit 12 receives the operation state from the access managing unit 11. With the above processes, the access managing unit 11 updates the disk information 21 while the power managing unit 12 updates the power management information 22.

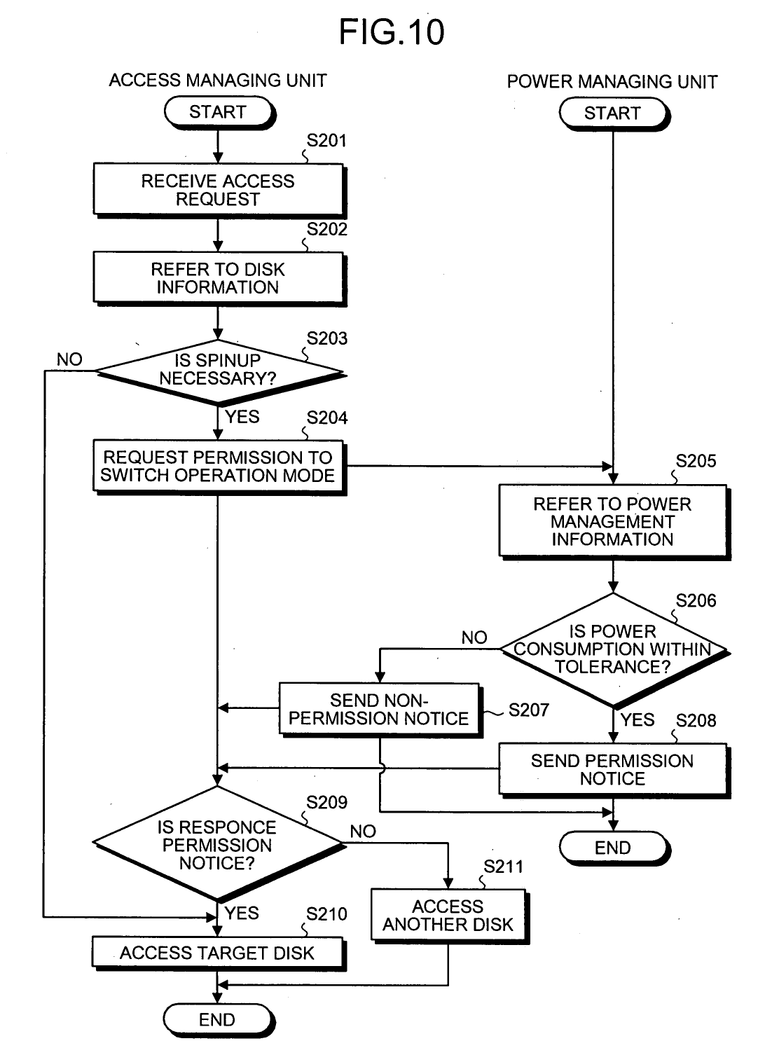

FIG. 10 is a flowchart of a power-saving disk management processing according to the embodiment. When the access managing unit 11 receives an access request to the disk device D from a server or the like (step S201), the access managing unit 11 refers to the disk information 21 (step S202) to check the operation mode of the disk device D.

If the disk device D is in the standby mode and a spindle motor of the disk device D needs to be activated (hereinafter, “spinup”) for performing an input/output (YES at step S203), the access managing unit 11 transmits a permission request for switching an operation-mode of the disk device D to the power managing unit 12 (step S204). On the other hand, if the disk device D is in the active mode and the spinup is not required (NO at step S203), the access managing unit 11 accesses (performs the input/output) the disk device D (step S210), and the process terminates.

Upon receiving the permission request from the access managing unit 11, the power managing unit 12 refers to the power management information 22 in the memory unit 20 (step S205). Thereafter, the power managing unit 12 determines whether the power consumption exceeds the tolerance assuming that the spinup is performed to the disk device D and that the disk device D is switched to be in the active mode (step S206). If it is determined that the power consumption is within the tolerance (YES at step S206), the power managing unit 12 sends a permission notice to the access managing unit 11 (step S208). On the other hand, if it is determined that the power consumption exceeds the tolerance (NO at step S206), the power managing unit 12 sends a non-permission notice to the access managing unit 11 (step S207).

Upon receiving a response from the power managing unit 12, the access managing unit 11 determines whether the response is the permission notice (step S209). If the response is the permission notice (YES at step S209), the access managing unit 11 accesses (performs the input/output) the disk device D (step S210), and the process ends. On the other hand, if the response is the non-permission notice (NO at step S209), the access managing unit 11 accesses (performs the input/output) a disk device different from the disk device D (step S211), and the process ends.

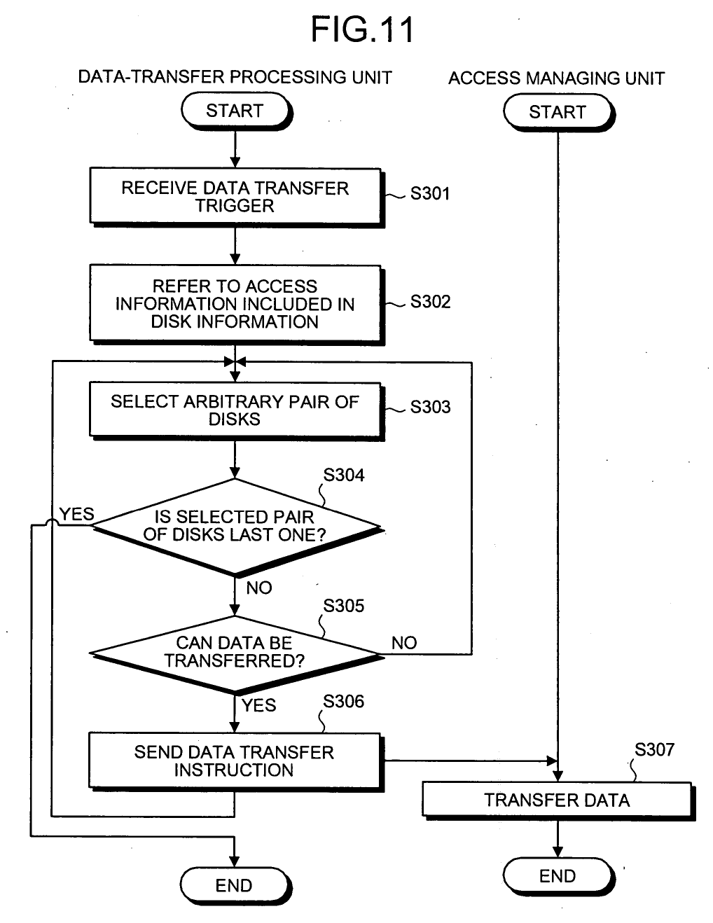

The data transfer processing is explained with reference to a flowchart shown in FIG. 11. Upon receiving a trigger (a trigger for starting the data transfer processing) from a timer or the like (step S301), the data-transfer processing unit 13 refers to the access information (see FIG. 8) included in the disk information 21 (step S302).

Thereafter, the data-transfer processing unit 13 selects an arbitrary pair of the disk devices A and B (step S303), and determines whether the selected pair of the disk devices is the last one among the disk devices 30 (step S304). If the selected pair of the disk devices is the last one (YES at step S304), the data-transfer processing unit 13 assumes that a series of the data transfer processing is completed, and the process ends. On the other hand, if the selected pair of the disk devices is not the last one (NO at step S304), the data-transfer processing unit 13 determines whether data can be transferred from one disk to the disk among the pair of disks based on the access information (step S305).

If data can not be transferred (NO at step S305), the data-transfer processing unit 13 repeats the process from step S303 to step S305 for another pair of disk devices. On the other hand, if the data can be transferred (YES at step S305), the data-transfer processing unit 13 sends a data transfer instruction to the access managing unit 11 (step S306).

Upon receiving the data transfer instruction from the data-transfer processing unit 13, the access managing unit 11 transfers the data from the disk device A to B (or B to A) (step S307), and the process ends.

As described above, according to the embodiment, the operation mode of each of the disk devices is by default set to the standby mode and the access managing unit continuously acquires the operation state of each of the disk devices. Upon receiving an access request for a target disk device, the access managing unit checks the operation mode of the target disk device. If the target disk device is in the standby mode, the access managing unit sends a query about accessibility of the target disk device to the power managing unit. Upon receiving a permission from the power managing unit, the access managing unit accesses the target disk device, so that the target disk device is put in the active mode. In addition, the data-transfer processing unit performs a process of transferring frequently-accessed data to a frequently-accessed disk device. As a result, it is possible to realize a high power-saving effect by effectively switching the operation mode of the target disk device to be in a power-saving mode.

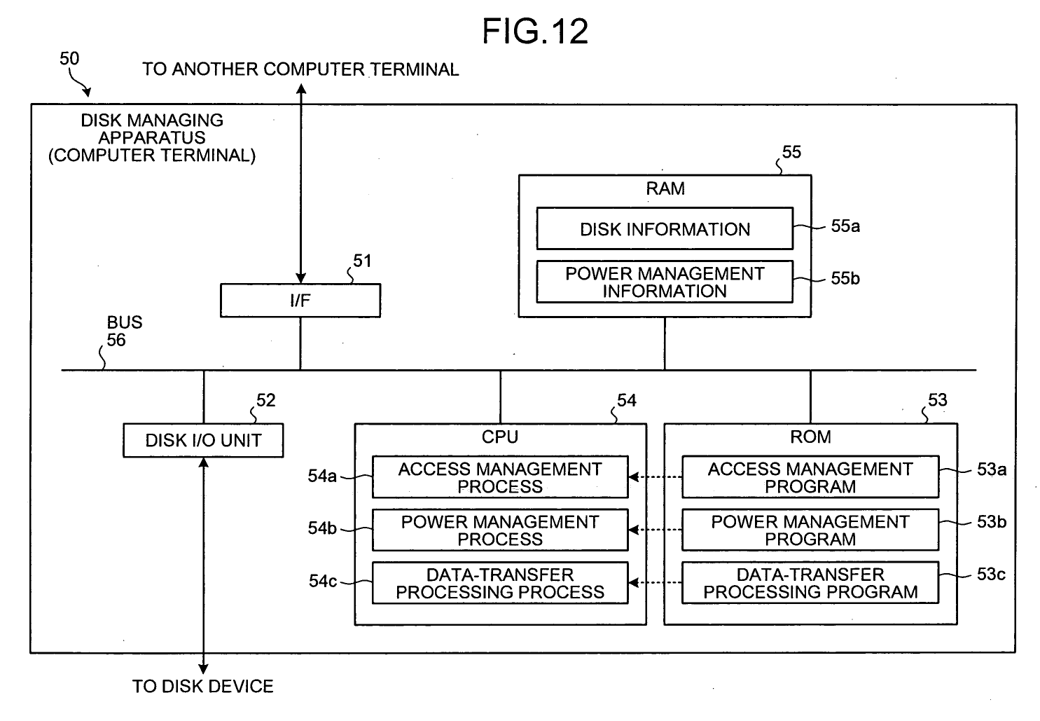

The operation procedures explained in the above embodiment can be realized by causing a computer terminal to execute a predetermined computer program. FIG. 12 is a block diagram of a computer terminal that executes an access management program, a power management program, and a data-transfer processing program, which have same functions as explained in the above embodiment.

As shown in FIG. 12, a computer terminal 50 used as a communication terminal device is configured to connect an interface (I/F) 51, a disk input/output (I/O) unit 52, a read only memory (ROM) 53, a central processing unit (CPU) 54, and a RAM 55, via a bus 56. The I/F 51 and the disk I/O unit 52 correspond to the access managing unit 11 shown in FIG. 4.

The ROM 53 stores therein an access management program 53a, a power management program 53b, and a data-transfer processing program 53c. The access management program 53a corresponds to the access managing unit 11, the power management program 53b to the power managing unit 12, and the data-transfer processing program 53c to the data-transfer processing unit 13.

The CPU 54 reads out the above programs to execute, so that the access management program 53a serves as an access management process 54a, the power management program 53b as a power management process 54b, and the data-transfer processing program 53c as a data-transfer processing process 54c.

The RAM 55 stores therein disk information 55a that corresponds to the disk information 21, and power management information 55b that corresponds to the power management information 22.

It is not necessary to store the above programs in the ROM 53 in advance. For example, it is acceptable to store the programs in a removable physical medium, such as a flexible disk (FD), a compact disk-read only memory (CD-ROM), or a magneto optical (MO) disk, from which the computer terminal 50 can read out the programs. Alternatively, it is acceptable to store the programs in another computer or a server connectable to the computer terminal 50 via a public line, the Internet, a local area network (LAN), or a wide area network (WAN), so that the computer terminal 50 can read out the programs to execute.

According to an embodiment of the present invention, a high power-saving effect can be realized by effectively switching an operation mode of a target device to be in a power-saving mode.

Furthermore, according to an embodiment of the present invention, a high power-saving effect can be realized by managing the operation mode of a target information storage device so that power consumption does not exceed a tolerance value.

Moreover, according to an embodiment of the present invention, a high power-saving effect can be realized by switching the operation modes of a number of the information storage devices to be in a standby mode.

Furthermore, according to an embodiment of the present invention, a high power-saving effect can be obtained.

Moreover, according to an embodiment of the present invention, it is possible to increase an input/output operation speed by reducing a management load.

Furthermore, according to an embodiment of the present invention, it is possible to save power of a magnetic disk device, so that it is possible to reduce a power consumption of the entire storage device or a storage system to which the magnetic disk device is connected.

Moreover, according to an embodiment of the present invention, it is possible to effectively manage the information storage device included in a power supply block such as a chassis, a lack, or a blade.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An apparatus comprising:
a storage unit that stores therein operation information indicative of operation state of each of a plurality of information storage devices;
a power calculating unit that calculates power information including current power consumption of each of the information storage devices and total power consumption of all the information storage devices based on the operation information; and
an access managing unit that, upon receiving an access request for a target information storage device, checks if the target information storage device is in a standby state from the operation information in the storage unit, and if the target information storage device is in the standby state, switches the target information storage device to active state and permits access to the target information storage device when the power information satisfies certain condition.

2. The apparatus according to claim 1, wherein the access managing unit permits access to target information storage device when the total power consumption does not exceed a tolerance value.

3. The apparatus according to claim 2, wherein the operation information includes access frequency of each of information storage devices, and apparatus further comprising:
a data transferring unit that transfers data from a first information storage device that is relatively less frequently accessed to a second information storage device that is relatively more frequently accessed, based on an access frequency in the operation information.

4. The apparatus according to claim 2, wherein the access managing unit switches an information storage device that is in an active state to a standby state when an access request corresponding to that information storage device is not received for a predetermined time.

5. The apparatus according to claim 2, wherein an information storage device automatically switches from an active state to a standby state when that information storage device is not accessed for a predetermined time.

6. The apparatus according to claim 3, wherein the information storage device is a magnetic disk device and the standby state is a state in which a spindle motor of the magnetic disk device is standstill.

7. The apparatus according to claim 1, wherein the information storage devices are divided into a plurality of power supply blocks, and the apparatus comprising one access managing unit for each of the power supply blocks.

8. A method comprising:
storing in a storage unit operation information indicative of operation state of each of a plurality of information storage devices;
calculating power information including current power consumption of each of the information storage devices and total power consumption of all the information storage devices based on the operation information; and
managing, upon receiving an access request for a target information storage device, including checking if the target information storage device is in a standby state from the operation information in the storage unit, and if the target information storage device is in the standby state, switching the target information storage device to active state and permitting access to the target information storage device when the power information satisfies certain condition.

9. The method according to claim 8, wherein the managing includes permitting access to target information storage device when the total power consumption does not exceed a tolerance value.

10. The method according to claim 9, wherein the operation information includes access frequency of each of information storage devices, and method further comprising:
transferring data from a first information storage device that is relatively less frequently accessed to a second information storage device that is relatively more frequently accessed, based on an access frequency in the operation information.

11. The method according to claim 9, wherein the managing includes switching an information storage device that is in an active state to a standby state when an access request corresponding to that information storage device is not received for a predetermined time.

12. The method according to claim 9, wherein an information storage device automatically switches from an active state to a standby state when that information storage device is not accessed for a predetermined time.

13. The method according to claim 10, wherein the information storage device is a magnetic disk device and the standby state is a state in which a spindle motor of the magnetic disk device is standstill.

14. The method according to claim 8, wherein the information storage devices are divided into a plurality of power supply blocks, and the method comprising separately performing the managing for each of the power supply blocks.

15. A computer-readable recording medium that stores therein a computer program that causes a computer to execute:
storing in a storage unit operation information indicative of operation state of each of a plurality of information storage devices;
calculating power information including current power consumption of each of the information storage devices and total power consumption of all the information storage devices based on the operation information; and
managing, upon receiving an access request for a target information storage device, including checking if the target information storage device is in a standby state from the operation information in the storage unit, and if the target information storage device is in the standby state, switching the target information storage device to active state and permitting access to the target information storage device when the power information satisfies certain condition.

16. The computer-readable recording medium according to claim 15, wherein the managing includes permitting access to target information storage device when the total power consumption does not exceed a tolerance value.

17. The computer-readable recording medium according to claim 16, wherein the operation information includes access frequency of each of information storage devices, and computer program further causing the computer to execute:
transferring data from a first information storage device that is relatively less frequently accessed to a second information storage device that is relatively more frequently accessed, based on an access frequency in the operation information.

18. The computer-readable recording medium according to claim 16, wherein the managing includes switching an information storage device that is in an active state to a standby state when an access request corresponding to that information storage device is not received for a predetermined time.

19. The computer-readable recording medium according to claim 17, wherein the information storage device is a magnetic disk device and the standby state is a state in which a spindle motor of the magnetic disk device is standstill.

20. The computer-readable recording medium according to claim 15, wherein the information storage devices are divided into a plurality of power supply blocks, and the method comprising separately performing the managing for each of the power supply blocks.
